(19) United States
(12) Patent Application Publication
(10) Pub. No.: US 2006/0172026 A1
(43) Pub. Date: Aug. 3, 2006

(54) Press and method for producing panel board

(76) Inventor: Josef Stutz, Niederteufen (CH)

Correspondence Address: SCHWEITZER CORNMAN GROSS & BONDELL LLP, 292 MADISON AVENUE - 19th FLOOR, NEW YORK, NY, 10017, US

(21) Appl. No.: 10/547,111

(22) PCT Filed: May 17, 2003
(86) PCT No.: PCT/EP03/05207

§ 371 Date: Aug. 26, 2005

(30) Foreign Application Priority Data
Feb. 26, 2003 (DE) 203 03 207.1

(51) Int. Cl. B29C 43/48

(52) U.S. Cl. 425/149; 425/373

(57) ABSTRACT

The invention relates to a pressing device (1) for the continuous production cleaning device (6) is arranged at a carrier web (7) that can be driven in a circulating manner by means of a drive (8), essentially in a direction that is transversal to the direction of movement of the press belt (6) wherein a surface pressure is brought onto a chip or fiber mat (2) that is provided with a binding agent between a circulating press belt (5) and a press drum (3) wherein a cleaning device (6) can be brought against the press belt (5) essentially over its entire width. The cleaning device (6) is arranged at a carrier web (7) that can be driven in a circulating manner by means of a drive (8), essentially in a direction that is transversal to the direction of movement of the press belt (6). Furthermore, a working method for the continuous production of chip or fiber boards is disclosed wherein a chip or fiber mat provided with a binding agent is subjected to a line pressure between a press drum and a pressure roller and additionally, a surface pressure between a circulating belt and a press drum, in order to generate a desired raw density, characterized in that at first, a desired nip width between the press drum and the pressure roller is set, and subsequently, the line pressure that determines the raw density is set by a change in the material supply of the chip or fiber web.

### BACKGROUND OF THE INVENTION

The invention relates to a pressing device for the pressing of glued chips and fibers, in particular for the production of boards consisting mainly of wood components, as well as a method for producing such boards.

In particular, the invention relates to a device for the continuous production of chip and fiber boards by means of a press drum and a pressure roller for producing a desired raw density of the chip or fiber boards, as well as a circulating press belt, in particular steel belt, by means of which the chip or fiber boards can be pressed flatly against the circumference of the press drum, wherein a cleaning apparatus of the device can be brought into contact with the press belt essentially over its entire width.

Furthermore, the invention relates to a device and/or working method for the continuous production of chip and fiber boards in which a line pressure is applied onto the chip or fiber web, which has been provided with a binding agent, between a press drum an a pressure roller, and, additionally, a surface pressure is applied between a circulating belt and the press drum, in order to produce a desired raw density.

Such a pressing device is basically arranged as follows. Chip material and/or fiber material that is arranged in layers to form a mat and which can, in particular, be pre-compacted, is brought between rollers. Such a mat is also called non-woven fabric or chip web or fiber web. A circulating belt or press belt, in particular a steel belt, can be spanned by rollers. In that case, the chip material is brought between one steel belt or two steel belts. Temperature is applied during pressing. The resin hardens during this. When the compacted mat leaves the pressing device, the final product is on hand in the form of a chip board, a fiber board, an HDF board or an MDF board.

In the simplest case, the pressing device comprises a total of four rollers, and one steel belt is guided around one pair of rollers respectively. In the beginning, two rollers have a certain distance to each other. The belts are brought together in the shape of a funnel in the direction of heating plates. The compaction itself takes place at the heating plates. Due to the funnel shape, the supplied material is being compacted continuously. Temperature is applied gradually. Due to the funnel shape, the material arrives in the press and does not pile up in front of the press.

It is disadvantageous that such a press, therefore, is relatively long. The funnel requires a space of around 3 m. Temperature is applied gradually. This also causes the required installation space for such a pressing device to be relatively large and that relatively large pressing times result. At present, pressing times typically are at about 6 to 8 seconds per millimeter thickness of the boards.

In order to achieve shorter pressing times and smaller installation space, it is intended in another embodiment of the press to introduce the material into the press diagonally from above. Due to this measure, one can compact the material immediately and suddenly without the material piling up in front of the press. Because of the sudden compaction, the funnel-shaped feed may be dispensed with. Because of this, space and pressing time are saved. One can approximately halve the pressing time per millimeter board thickness.

The steel belts may be dented during pressing. The dents influence the quality of the future product. If two belts are used for pressing, the risk with respect to dents and negative influences on the product doubles correspondingly.

In order to avoid this problem and/or to reduce the problem, it is intended, in an improved embodiment, to guide the pre-glued chip or fiber material around a heating drum, which is also called pressing drum or calendar, during pressing. A steel belt is guided around three-quarters of the heating drum. Approximately one-quarter of the heating drum remains free. The material is brought to the drum from this side diagonally. The heating drum which consist of steel is unsusceptible to the formation of dents. In this way, one can halve the damage to the product due to the formation of dents in the steel belt.

Since the fiber mat is guided around the drum in the above-mentioned case, it exhibits a curvature at first. The curvature is compensated in post-conditioning. The final result is a plane board. The precondition for this, however, is that the board is sufficiently thin. In this device, boards of a thickness of up to 10 millimeters can be produced. Due to post-conditioning, the boards even out to such a degree that the final result is a plane board product.

In the aforementioned device, a main roller having a particularly large diameter can be provided which serves as a pressing drum. The press belt is guided around three-quarters of this main roller. Several smaller pressure rollers are grouped around the main roller. The press belt is guided between the pressure rollers and the main roller. The pressure rollers press in the direction of the main roller.

In order to generate the desired heat, the main roller and the pressure rollers are heated. In this way, temperatures of up to 250° C. are typically generated. The higher the temperature selected, the faster the glue sets.

In order to be able to produce quickly, a high circulating speed of the press belt and of the associated small rollers as well as of the main roller is provided. The faster the speed of the rotating roller, the faster temperature must be applied to the main roller and the press belt.

It is a known measure for the quick application of temperature to raise the heating power accordingly. This measure reaches its limit when the thermal energy to be provided is so large that too much strain is put on the material. Damages occur in the device if temperatures are too high.

### DESCRIPTION OF THE PRIOR ART

A device and/or a working method of the above-mentioned kind is known, for example, from DE-OS 20 50 325. Here, a continuously operating press is disclosed in which chip or fiber boards are being pressed continuously and subsequently cut to length. The webs have a thickness of 0.8 to 12 mm and a width of 2,500 mm. The pressing of the chip and fiber boards takes place between the circumference of the rotating and heated pressing drum and the circulating steel belt, which is under a large tensile stress. In addition, the line pressure required for generating the desired raw density is applied by means of a pressure roller that lies against the steel belt on a side of the steel belt that faces away from the chip or fiber board. To this end, the chip or fiber boards introduced into the press are guided through the press by means of a circulating steel belt while maintaining a required surface pressure, and are pressed under heat at the circumference of the press drum during the contact time.

Furthermore, it is also known from DE 39 03 022 C1 to move the two bearing bodies of the pressure roller independently from each other in order to be able to reproduce a distance set at first on one side of the press belt on the opposite side of the press belt. It is of decisive significance in practical operation that a trouble-free circulation of the press belt is ensured because the continuous operation would have to be interrupted otherwise. In particular, dirt must be avoided which can come between the press belt and the pressure roller and thus cause deformation of the press belt. It may basically be known to mount a cleaning apparatus in the form of a brush on the device so that this lies flatly against the surface of the press belt, however, in particular the different distance between the press drum and the pressure roller and fluctuations in the tension of the press belt prove to be impediments because, due to them, the required cleaning effect cannot be ensured in every case. In order to solve this problem, it has been tried to mount the cleaning apparatus at a movable holding means associated with the pressure roller so that the various positions of the press belt can be compensated immediately. This measure, however, has proven to be promising only to a limited degree.

Furthermore, a device and/or a working method is known from DE 39 03 022 C1 in which, in the loaded state of the press, only one of the two bearing bodies that support the pressure roller on both sides moves in the direction of the axis of rotation of the press drum at first until a predetermined pressure is reached. The distance between the press drum and the pressure roller which is determined by the compressive force is subsequently measured by means of a first distance sensor. Then, the opposite bearing body is moved so that the distance measured by means of a second distance sensor on that side of the pressure roller essentially matches the distance measured by the first distance sensor, and hence, a uniform nip width is set over the entire width of the chip or fiber web. The complex setting of the distance on both sides of the chip and fiber web proves to be disadvantageous in this method. In particular, a continuous acquisition and correction of the nip width measured on one side by shifting the bearing body on the opposite side of the pressure roller is necessary in order to ensure a uniform thickness of the material over the entire width of the chip or fiber web. The control system thus created requires a capability for very fast adjustment of the bearing bodies that entails large costs in practical use. Furthermore, a constant thickness of the material of the chip or fiber web over a great length cannot be ensured due to this principle. In addition, this method cannot be realized with the presses that are commonly used in practice and which have been known for decades, in which the pressure roller can be moved in a parallel direction to the press drum in order to set the nip width in a simple manner, and therefore requires complicated adaptive solutions.

### SUMMARY OF THE INVENTION

Therefore, the invention is based on the object of providing a device and/or method of the generic type which avoids the above-mentioned disadvantages of the generic state of the art.

In this case, the invention is also based on the object to design a device for the continuous production of chip or fiber boards of the type mentioned at the beginning in such a manner that its operation is improved due to a significantly increased cleaning performance. In particular, dirt on the press belt is to be removed reliably by the cleaning apparatus under all operational conditions that occur.

One object of the invention is the acceleration of the production process given a relatively small installation space that must be cleared for the press. Altogether, therefore, production costs are to be reduced.

The invention is also based on the object of creating a device and/or working method for the continuous production of chip of fiber boards in such a way that a thickness of material that remains constant over great lengths can be achieved at a desired raw density with little effort. In particular, the method is to be implementable in continuous presses that are known per se, and which have a capability of uniform adjustability of the nip width over the entire width of the chip or fiber web.

The object of the invention is achieved by means of a device and/or a working method having the features of the independent claims. Advantageous embodiments result from the dependent claims.

According to the invention, a device is provided in which the cleaning apparatus is arranged at a carrier web that can be driven in a circulating manner by means of a drive, substantially in a transversal direction relative to the direction of movement of the press belt. Thus, the cleaning performance of the cleaning apparatus is substantially improved by it being moved in a direction transversal to the direction of movement, because of which a significantly higher relative speed of movement is realized. To this end, the cleaning apparatus is arranged at a circulating press belt and thus makes continuous cleaning possible, where the circulating speed may also be determined, for example, in accordance with the feed motion of the press belt that is to be cleaned. Compared to an embodiment of the holding means that is also conceivable and in which this can, for example, be arranged in a reversing manner or at a rotating brush roller, uniform cleaning performances over the entire width of the press belt are realized with the cleaning apparatus that is driven in a circulating manner. For this purpose, the cleaning apparatus and the carrier web may also be connected in one piece.

A particularly advantageous embodiment of the present invention can also be realized by the carrier web being fixable in different positions at a holding means of the device. In this manner, the carrier web that has the cleaning apparatus can be set in accordance with the respective position set for the press belt as well as with the respective operational conditions.

Here, it is particularly effective if the carrier web is arranged at a holding means such that it can be set with at least two degrees of freedom, for adjustment to the relative position and/or orientation of the press belt. In this simple manner, it becomes possible to ensure that the cleaning apparatus lies flat on the press belt. To this end, the carrier web is, for example, moved in the direction of the press belt and, additionally, inclined about its longitudinal axis until the desired flat contact is ensured.

Another particularly practice-oriented embodiment of the method according to the invention is achieved when the carrier web is movable by means of a hydraulic or pneumatic cylinder in order to make a continuous adjustability of the carrier web including the drive possible.

The adjustment of the optimal relative position between the cleaning apparatus and the press belt could be realized by means of a mechanic connection between the adjustable pressure roller and a bearing of the carrier web. In contrast, a modification is particularly promising in which the device has a sensor for acquiring the relative position and/or orientation of the press belt. Through this, already very small deviations of the press belt from the respective position and inclination can be acquired and a corresponding compensating motion can be immediately initiated. In this case, the cleaning apparatus can be moved independently from the pressure roller.

In addition to this, it proves to be particularly useful if the device has a sensor for determining the contact force of the cleaning apparatus towards the press belt in order to be able to set a pressure of the cleaning apparatus towards the press belt that is suitable for maintaining an optimal cleaning performance.

As an addition to this, it proves particularly helpful if the device is additionally provided with a second sensor, wherein one sensor, respectively, is allocated to one of the two edge regions of the press belt. In this way, changes in the orientation can be determined reliably and thus, deviating cleaning effects between the two edge regions of the cleaning belt can be avoided.

The cleaning apparatus could have woven fabric, knitted fabric, a foam or a textile and/or fibrous surface. However, a variation has proved particularly suitable for cleaning such belts in which the cleaning apparatus has a brush and, in addition, according to a further advantageous modification, a wear indicator, in order to be able to perform an exchange of the wearing parts prior to an inadmissible limitation of the cleaning performance.

According to the invention, an object of the invention is achieved, at first, by the pre-compacted mat being introduced to the press diagonally from above.

In order to reach high processing speeds, in an advantageous embodiment of the invention, the press belt is not only heated by the above-mentioned small rollers. In addition or alternatively, temperature is applied to the press belt from the outside immediately at the area involved in the step of pressing, according to the invention. In this way one can succeed in introducing a pre-heated belt into the area that serves for pressing itself. Since the press belt is already pre-heated, the press belt can be brought to the desired temperature much faster in the pressing area. Thus it is possible to increase the circulating speed without having to provide such a heating power at the pressure roller that leads to damage of the device.

Thus, temperature can be applied to the press belt by thermal radiation through heaters that are located near to the press belt outside of the pressing area itself.

In the device according to the invention, in one embodiment, there are not only the aforementioned pressure rollers that lie under pressure against the main roller. Another, also smaller roller is provided which hereinafter will be referred to as tension roller. By moving the tension roller accordingly, one can succeed in tightening the press belt. In this way, the pressing pressure is set with which the pre-compacted mat is pressed within the press. In order to keep the number of components to be used small, the temperature is also applied via the tension roller. In this way, it is possible to feed a pre-heated belt into the area which serves for the pressing itself. Since the press belt is already pre-heated, the press belt can be brought to the desired temperature more quickly in the pressing area. Thus it is possible to increase the circulating speed without having to provide a heating power at the pressure roller that leads to damage of the device.

In order to further increase the pressing speed, the diameter of the pressure rollers are further increased compared with the state of the art. In this manner, the contact surface between the press belt and the pressure roller concerned increases. The larger contact surface makes an improved, and thus faster, energy input possible. In addition, the energy transmitted per unit of area decreases which can lead to local overheating despite an energy transfer that is insufficient for hardening. Due to this further measure, it is also ensured that the desired temperature is provided in the pressing area at circulation speeds that have been further increased.

According to the state of the art, the smaller pressure rollers have a diameter of up to 2 meters. According to the invention, one or more pressure rollers are used that have a diameter of more than 2 meters, preferably of more than 2.5 meters.

According to the invention, in one embodiment, the steel belt is guided around smaller rollers or pressure rollers. The smaller the diameter of a smaller roller is, the more the steel belt is being bent. The more it is being bent, the more it is put under stress. Thus, the life expectancy of the steel belt is lowered accordingly. By providing the aforementioned larger diameters it is furthermore possible to increase the life expectancy of the steel belt accordingly. Costs are also being saved in this way. This size also applies for the tension roller if the tension belt moves around the tension roller around a segment of a circle that leads to stress, e.g., more than 45°.

By heating the tension roller and other areas outside of the pressing area itself, the steel belt is altogether brought to a desired temperature in a more uniform way. Temperature gradients within the steel belts are thus kept small compared to the state of the art. Avoiding large temperature gradients also has the consequence of the life expectancy of the steel belt being increased accordingly. In comparison to the state of the art, attention is being paid in the invention to increase life expectancy of the steel belt by a more uniform heating. Thus, production costs are also lowered, since the steel belt is very expensive.

In very large presses, a steel belt may cost up to 1 million euros. In a preferred embodiment of the invention, a comparably short steel belt can be used. Correspondingly, the provision costs are significantly reduced. Thus, production costs are further saved.

Preferably, the rollers are heated in the following manner. Bore holes are provided close to the surface of the cylindrical roller. The bore holes have a supply and a drain at their ends. The supply takes place from the one end face of the roller. The draining takes place via the other end face of the roller. Hot liquid, in particular hot oil, is guided over the axes through the bore holes. In this way, the circumferential surface concerned is heated correspondingly. The hot liquid, and thus, in one embodiment, the hot oil, leaves the roller through one drain and is guided back in a cycle. During guidance in the cycle, the oil is being heated outside of the roller. The oil is heated preferably by a combustion process. In this way, wood dusts that are left over from the production of the fibers and/or chips can be used for heating the rollers. Wood dust can therefore be used for heating. The waste product wood dust is thus directly used for the production process. Transport distances for fuel are thus reduced accordingly.

In an advantageous embodiment of the invention, the main roller can also be heated in the aforementioned manner.

In order to further improve the production process, in one embodiment, a contact pressure of the pressure rollers against the main roller of more than 8,000 N per centimeter, preferably of more than 10,000 N per centimeter, in the axial direction of the main roller is provided.

When the non-woven material is fed between the main roller and he first pressure roller diagonally from above, at first, a sudden compaction takes place which is also called line pressure. The mat will subsequently expand again. This generates an undesired density distribution in the surface region of the board which has a negative effect on the surface hardness that is a significant property of the board. In order to avoid this undesired and, mostly, relatively irregular density distribution, additional very small rollers are installed immediately behind the pressure roller which preferably further decrease the nip width. Typical diameters of the very small rollers, which are smaller than the first aforementioned pressure rollers, are 300 to 450 mm. In an advantageous embodiment of the invention, it was found that these very small rollers press against the main roller with a contact pressure of at least 150 N per centimeter in axial direction. In this way, the density distribution in the surface region of boards to be produced is substantially improved. A jagged or wave-like curve in the density distribution in the surface region is thus avoided. A board is created which has a particularly high density in the surface region. The density decreases towards the middle of the board. In contrast to a press without the very small rollers, a jagged density curve is avoided in the surface region.

The desired high surface density which is provided, in particular, by the sudden compaction, is desired. Due to this, for example, the amount of varnish needed in a subsequent step of varnishing the surface is reduced. In this case, the varnish is unable to penetrate into the product which would increase varnish usage. Compared to conventional pressing devices, around 20 to 30 per cent of varnish are saved in a subsequent varnishing step. In addition, the hard surface is also decisive for the wear resistance and the prevention of dents during use. A soft core improves footfall sound absorption.

The very small rollers are directly adjacent to the first pressure roller over which the material is fed diagonally. Several very small rollers are used. In one embodiment, at least two very small rollers are provided which prevent the expansion of the mat within the pressing area.

In advantageous embodiment, at least four very small rollers are used.

In order to obtain a product of high quality, the tensile force with which the tension roller tightens the press belt amounts to at least 25 N per cm². Preferably, the tensile force amounts to 30 N per cm² and more.

Further very small rollers, so-called trimming rollers, are installed downstream from the very small rollers. These further very small rollers are preferably located in the upper area close to the location where the board leaves the press. These further very small rollers have in their interior hydraulic cylinders. By the hydraulic cylinders in the interior of the further very small rollers that are arranged in the upper area, the surface of the very small rollers or the circumferential surface can be deformed. The surface regions or the circumferential surface can thus be adjusted individually along the axis. By controlling the hydraulic cylinders suitably, the pressing can be adjusted in the upper area so that the desired thickness of the boards can be specifically adjusted in that area. Thus it is possible to further reduce deviations from the desired thickness of the boards. Accordingly, a subsequent abrading step can be avoided or even entirely dispensed with in order to obtain the ideal desired thickness of the board.

When the steel belt circulates around the various rollers, the steel belt tends to leave the ideal track in a lateral direction relative to the direction of movement and to run off the roller. This problem is becomes greater at larger circulation speeds. In order to avoid this problem, the run of the steel belt is continuously scanned. To this end, mechanical and/or optical sensors are used. If a press belt threatens to leave the ideal track, a corresponding roller or the axis is continuously positioned differently. Thus, adjusting means with which the axis or the direction of the axis can be changed are provided at every roller. Dependent upon the leaving of the ideal track, the axis is continuously adjusted so that the press belt is guided back onto the ideal track. By continuous scanning and the continuous adjustment of the directions of different axes, a sudden adjustment is avoided. A correction of the position of the belt by sudden adjustment would have the consequence of the quality of the surface of the steel belt would be influenced due to the forceful lateral shifting. This would degrade the quality of the product accordingly.

In a further embodiment of the invention, there is an electronic control for urging the smaller rollers parallel against the main roller. The axes of the one smaller roller are moved hydraulically in the direction of the main roller. Every hydraulic element to the right and the left of the main roller can be activated and moved individually. By means of an electronic system, the at least two hydraulic elements to the right and the left of smaller roller are moved so that a smaller roller is guided towards the main roller absolutely parallel.

In a further embodiment of the invention, the, in particular, pre-compacted mat is brought to the area by a belt from which the pre-compacted mat is introduced into the press diagonally from above.

In a further embodiment of the invention, a relatively large entry nip, i.e. nip width, is set at the beginning of the continuous pressing of an, in particular, pre-compacted mat. At this point in time, one or more small rollers have not been set to the actual contact pressure in the direction of the main roller. Only when a pre-compacted mat leaves the pressing device again, the desired final pressure is set with which the smaller rollers press in the direction of the main roller. In this way, it is possible to reduce the starting power required. The pressing device can therefore be designed with smaller starting powers. This reduces the costs of the pressing device. In total, the production costs are thus reduced further.

In order to be able to monitor production, the device comprises a casing having various viewing windows. Through the viewing windows, the production inside the press can be monitored manually. Further more, a cleaning of the inside can be performed through the aforementioned holes in the casing.

In a further embodiment of the invention, a so-called transfer table is located in front of the entry area into the press. The pre-compacted mat is guided towards the transfer table by means of a conveyor belt. The transfer bridges the distance between the feed itself into the press and the conveyor belt. In this manner, the proper feed of the pre-compacted mat is ensured.

In a further embodiment of the invention, means for heating the transfer table are provided. Thus, the pre-compacted mat is already pre-heated immediately prior to entry into the pressing device. By the additional application of temperature immediately prior to entry into the pressing device, it is possible to further shorten the pressing time. In total, the production rate is thus increased further.

In a further embodiment of the invention, the transfer table is designed so that through it, hot vapor can be conveyed to the pre-compacted mat. By conveying vapor, the pre-compacted mat is preheated further in a suitable manner. By conveying vapor, the temperature is transported very quickly into the interior of the mat. Thus, production is improved further in a suitable manner.

In a further embodiment of the invention, means for heating the pre-compacted mat from above and/or for conveying vapor are provided above the transfer table. Thus, from both sides and immediately prior to entry into the pressing device, the mat is preheated and heat is brought into the interior of the mat by the vapor blast. Thus, production can be increased further.

In order to ensure the quality of production, there is an apparatus having brushes with which the main roller is continuously brushed off. Preferably, steel brushes are used for brushing off the main roller that consists of steel.

In order to improve production further, a polishing apparatus is provided in a further embodiment of the invention, with which the main roller can be polished during production. Both aforementioned treatment apparatuses, i.e. the brushing apparatus and the polishing apparatus can be moved in an oscillating manner parallel to the circumferential surface. In this manner, a uniform result of the treatment is ensured.

Furthermore, apparatuses are provided to drive the treatment apparatuses, i.e. the brushing apparatus and the polishing apparatus towards the main roller or to drive them away from the main roller.

According to the method, it is intended to brush continuously during production. The polishing apparatus is only driven up if needed.

The polishing apparatus abrades the main roller if needed. Preferably, this is a roller with an abrasive belt. By means of the abrasive belt, the surface of the main roller is abraded if needed. The surface of the polishing apparatus preferably has a very fine-grain corundum material.

The polishing apparatus is engaged when shading is registered on the surface of the main roller. This can take place by means of optical sensors. In practice, however, it is also possible to have a person monitor the quality of the surface at the main roller. The person manually causes the polishing apparatus to be engaged when a shading of the surface is registered.

Since a shading on the surface of a main roller becomes noticeable as a shading on the product, it is sufficient to monitor the quality of the board. If a shading is recognized here, the polishing apparatus is engaged according to the method.

In a further embodiment of the invention, one or more brushes are provided that brush off the press belt. In this manner, production quality is ensured further. Deposits on the press belt cannot lead to impeding the production quality.

In an advantageous embodiment of the invention, brushing takes place in a perpendicular direction relative to the direction of transport of the press belt. Thus, it is possible to sweep deposits on the press belt away to the side. Thus, deposits are prevented from piling up before the brushing apparatus and it is avoided that the brushing apparatus cannot cope anymore with the material in the end.

Preferably, a so-called belt brush is used. This is a circulating belt spanned by two rollers. The belt is provided externally with steel bristles. These are guided in a direction perpendicular relative to the direction in which the press belt is guided. In this manner, deposits are swept away to the sides. Accordingly, product quality is ensured.

In a further embodiment of the invention, the brushing apparatuses are arranged movably. By moving them, it is possible to provide a desired distance between a brushing apparatus and the press belt. This moving is necessary particularly when new board thicknesses that are to be produced are set. In this case, the distance between a smaller roller and the main roller is suitably changed. Thus, the run of the press belt changes to a small degree. An optimum result of brushing is ensured by tracking being possible.

In a further embodiment of the invention, a polishing apparatus is provided with which the press belt can be polished.

This polishing apparatus for the press belt can also be driven towards the press belt only if the need arises. It is engaged when the production quality deteriorates and a polishing of the main roller does not lead to a sufficient improvement of the product.

Furthermore, a working method is disclosed which can be performed particularly well on a device according to the invention: According to the invention, a working method is provided in which at first a desired nip width between the press drum and the pressure roller is set, and in which the line pressure that determines the raw density is set by a change in the supply of the material of the chip or fiber web. Thus, a uniform thickness of the material can be ensured also over a great length of the chip or fiber webs. In order to maintain the line pressure between the main roller and the pressure roller at a constant level at constant nip width, the material supply is changed in a simple manner. Thus, the method can also be carried out with conventional presses which do not have an independent means for setting the nip width for each respective side of the chip or fiber web. In addition, the effort for carrying out the method is significantly reduced because due to it, an adjustability of the bearing bodies that is independent from the current measured value acquisition can be dispensed with. The effort for regulating the material supply is comparably small.

In practice, a modification of the method according to the invention has proved to be particularly promising, if the line pressure is determined by means of a pressure sensor. The line pressure which is decisive for the required raw density can be determined by means of the pressure sensor and can be used as a control variable in the material supply. Thus, a raw density is ensured that is constant to a large degree, making it possible to achieve a significant improvement in quality at the same time.

A further particularly advantageous embodiment of the invention is achieved by one pressure sensor each being allocated to the lateral edge regions of the chip or fiber webs. Thus, varying pressure conditions can be detected over the width of the chip or fiber web and thus, the material supply can be adjusted accordingly in a different manner over the width of the chip or fiber web. Therefore, the method can be further optimized with little effort.

The material supply is basically determined by the volumetric flow rate of the chip or fiber substance forming the chip and fiber web. The amount supplied can be limited, for example, by means of a scalper roller.

Additional advantages follow from the following description and the attached drawing. The above-mentioned features that are explained further can also each be used together individually or in any combination with each other. The embodiments mentioned are not to be understood as being final and have an exemplary character. In particular, the invention is not limited to calendar presses and can also be transferred to double-belt presses.

The invention permits various embodiments. For the purpose of the further illustration of its basic principle, one of them is shown in the drawings and is described in the following. This shows, in

### BRIEF DESCRIPTION OF THE DRAWINGS

FIG. 1 a basic sketch of a device according to the invention in frontal view;

FIG. 2a basic sketch of a device according to the invention in side view;

FIG. 3 an enlarged rendering of details of the device shown in FIG. 1 in frontal view.

### DETAILED DESCRIPTION OF THE PREFERRED EMBODIMENTS

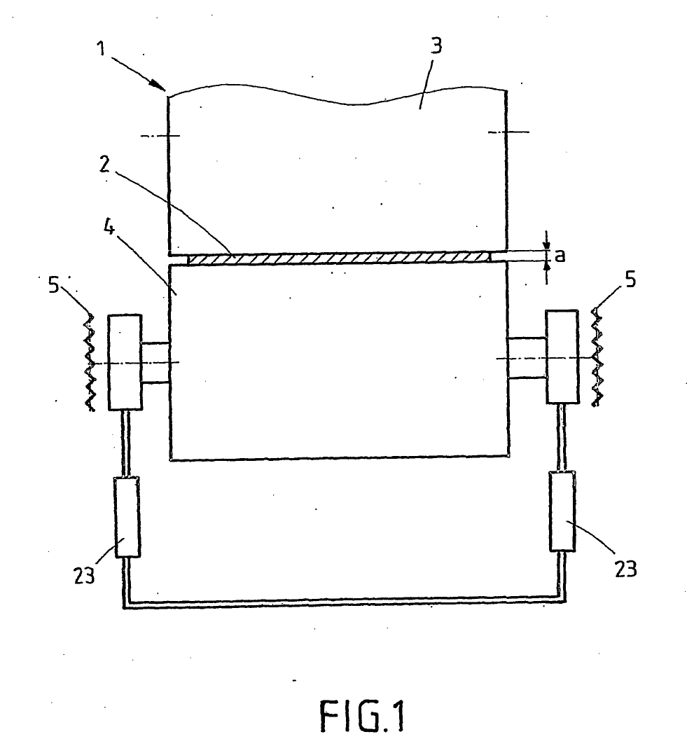

FIG. 1 shows a basic sketch of a continuous press 1 for the production of chip or fiber webs 2. To this end, the chip or fiber web 2 that is provided with a binding agent is pressurized with a line pressure between a press drum 3 and a pressure roller 4, which leads to the required raw density. In order to realize, at the same time, a constant material thickness over the entire width of the chip or fiber webs 2 at the required raw density, the desired nip width “a” is set by means of pressure roller 4 which is arranged movably by means of the hydraulic cylinders 23 that serve as adjusting means. During operation, the line pressure is continuously acquired by means of pressure sensors 5 and the material supply is altered, dependent upon the determined deviations from a set value, until the line pressure reaches a desired value. The hydraulic cylinders 23 serving as adjusting means can also be used independently from the pressure sensors, in order to set, at first, a relatively large nip width between the press drum 3 and the press belt 5 at the beginning of the continuous pressing of the fiber mat 2. Only when the mat leaves the pressing device again, the desired final pressure and/or the desired nip width is set, with which the pressure roller 4 or also the very small roller that are not shown press in the direction of the main roller.

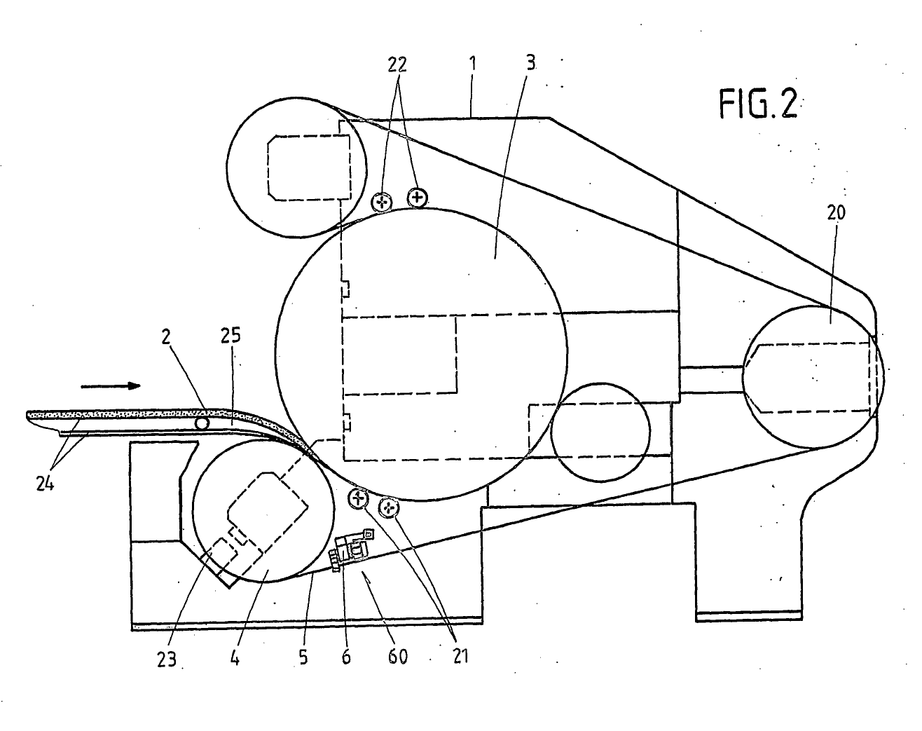

FIG. 2 shows a device 1 for the continuous production of chip or fiber boards 2, with a press drum 3 and a pressure roller 4. A circulating press belt 5 is arranged between the press drum 3 and the pressure roller 4, by means of which the chip or fiber boards 2 or the non-woven fabric are pressed flat against the circumference of the press drum 3. In order to prevent an undesired influence of dirt on the production process, cleaning means 60 having a cleaning apparatus 6 lie against the press belt 5 essentially over its entire width. The non-woven fabric 2 is conveyed over a transport belt 24 towards the entry of the press, where, in the area between the transport belt and the entry, the fabric is supported by a transfer table 25. The table is inclined downward in the direction of the entry.

Very small rollers 21 that decrease nip width urge the press belt 5 against the press roller 3 and prevent an expansion of the compacted non-woven fabric. In upper areas of the press, i.e., shortly before the pressed boards leaves the press, trimming rollers are provided which bring the pressed boards to the desired size and/or correct deviations from the size.

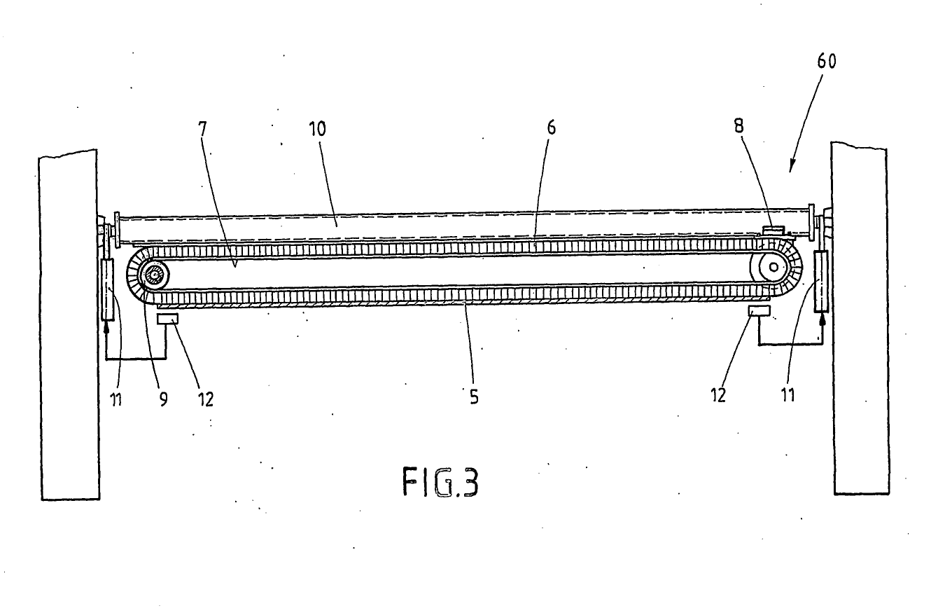

The exact mode of operation of this cleaning apparatus 6 is shown in more detail in FIG. 3, which shows an enlarged rendering of details of the device 1 shown in FIG. 2. The cleaning apparatus 6, which is designed as a brush, is arranged on the outside of an endless carrier web 7 that can be driven in a circulating manner by means of a drive 8, substantially in a transversal direction relative to the direction of movement of the press belt 5. The drive 8 and a bearing 9 of the carrier web 7 can be adjusted together in different positions with at least two degrees of freedom at a holding means 10 of the device 1. This purpose is served by pneumatic cylinders 11, by means of which the holding means 10 can be set in accordance with the relative position and orientation of the press belt that is determined by the sensors 1 2 associated respectively with one of the edge regions of the press belt 5.

The cleaning apparatus 6 in FIGS. 2 and 3 can also work against the bottom of the press belt 5 in order to remove particles that lie on the press belt and, in particular, are baked to it.

1. Pressing device (1) for the continuous production of chip or fiber boards, wherein a chip or fiber mat (2) provided with a binding agent is subjected to a line pressure between a press drum (3) and a pressure roller (4), as well as, subsequently, to a surface pressure between a circulating press belt (5) and the press drum (3), characterized in that
means (23) for setting the desired nip width between the press drum (3) and the pressure roller (4),
means for changing the supply of material of the chip or fiber web, as well as
a pressure sensor for acquiring the line pressure are provided.

2. Device (1) according to claim 1, characterized in that the chip of fiber boards (2) can be pressed flatly against the circumference of the press drum (3) by means of the circulating press belt (5), in particular a steel belt.

3. Device(1) according to claim 1, characterized in that the cleaning device (6) can be brought against the press belt (5) essentially over its entire width.

4. Device according to claim 3, characterized in that the cleaning device (6) is arranged at a carrier web (7) that can be driven in a circulating manner by means of a drive (8), essentially in a direction that is transversal to the direction of movement of the press belt (6).

5. Device according to claim 4, characterized in that the carrier web (7) can be fixed in different positions at a holding means (10) of the device (1).

6. Device according to claim 4, characterized in that the carrier web (7) is arranged adjustably with at least two degrees of freedom at the holding means (10) for adjusting it to the relative position and/or orientation of the press belt (5)

7. Device according to claim 4, characterized in that the carrier web (7) is mechanically movable, in particular by means of a hydraulic or pneumatic cylinder (11).

8. Device according to claim 1, characterized in the device (1) having a sensor (12) for acquiring the relative position and/or orientation of the press belt (5).

9. Device according to claim 1, characterized in that the device (1) has a sensor (12) for acquiring the pressure force of the cleaning device (6) on the press belt (5).

10. Device according to claim 1, characterized in the device (1) additionally being provided with a second sensor (12), wherein one sensor, respectively, is allocated to one of the two edge regions of the press belt (5).

11. Device according to claim 3, characterized in that the cleaning apparatus (6) has a brush or scraper.

12. Device according to claim 1, characterized in that the cleaning apparatus has a wear indicator.

13. Device according to claim 1, characterized in that, between the press drum (3) and a pressure roller (4), a line pressure is brought on the chip or fiber mat (2) that is provided with a binding agent, for the purpose of generating a desired raw density.

14. Device according to claim 1, characterized in that the mat (2) is introduced into the device diagonally from above.

15. Device according to claim 1, characterized in that the mat (2) is a pre-compacted mat.

16. Device according to claim 1, characterized in that heating means for heating the device are provided.

17. Device according to claim 16, characterized in that the heating means are also provided also outside of the area that is immediately involved in the pressing step, in particular the press drum, and supply heat in this area of the device.

18. Device according to claim 16, characterized in that the heating means are arranged so close to the press belt outside of the area immediately involved with the pressing step that they are able to heat the press belt.

19. Device according to claim 1, characterized in that a tension roller (20) is provided shiftably in such a way that the press belt (5) rolling off over the tension roller can be tightened so that the desired surface pressure can be set by this.

20. Device according to claim 19, characterized in that the tension roller (20) tightens the press belt (5) so that a surface pressure of at least 24 N/cm², preferably at least 30 N/cm² can be achieved.

21. Device according to claim 19, characterized in that the pressure roller (4) and/or tension roller (20) have a diameter of at least 2 meters, preferably of more than 2.5 meters.

22. Device according to claim 19, characterized in that the press drum (3), the tension roller (20) and/or pressure roller (4) are heatable.

23. Device according to claim 19, characterized in that the press drum, tension roller and/or pressure roller have a supply and a drain for a heat transfer medium, in particular hot oil.

24. Device according to claim 19, characterized in that the press drum, tension roller and/or pressure roller are provided in their circumferential surfaces with lines for the flowing-through of a heat transfer agent.

25. Device according to claim 24, characterized in that heating is provided for warming the heat transfer agent outside of the roller.

26. Device according to claim 25, characterized in that the heating can be operated by a combustion process, in particular by the combustion of wood dust.

27. Device according to claim 1, characterized in that further very small rollers (21) are installed immediately downstream from the pressure roller.

28. Device according to claim 27, characterized in that the very small rollers (21) are arranged so as to decrease nip width.

29. Device according to claim 27, characterized in that the very small rollers have a diameter of 300 to 450 mm.

30. Device according to claim 27, characterized in that the very small rollers press against the press roller with a contact pressure of at least 150 N per centimeter roller length.

31. Device according to claim 27, characterized in that the very small rollers are immediately adjacent to the first pressure roller in the feeding direction of the mat.

32. Device according to claim 27, characterized in that at least four very small rollers are provided that prevent the expansion of the mat within the pressing area.

33. Device according to claim 27, characterized in that at least four very small rollers are provided that prevent the expansion of the mat within the pressing area.

34. Device according to claim 27, characterized in that further very small rollers, so-called trimming rollers (22) are installed downstream from the very small rollers, which trimming rollers (22) are preferably arranged in the upper area of the device, where the board leaves the press.

35. Device according to claim 34, characterized in that means for deforming the circumferential surface, for example hydraulic cylinders, are provided in the interior of the trimming rollers (22) so that a desired board thickness or cross section of a board can be specifically set in this area.

36. Device according to claim 27, characterized in that it is designed in such a way that, at the beginning of a continuous pressing of the mat (2), a relatively large nip width between the press drum (3) and the press belt (5) is set at first, and that only when a mat leaves the pressing device again, the desired final pressure and/or the desired nip width is set with which the very small rollers press in the direction of the main roller.

37. Device according to claim 27, characterized in that means (5, 23) for continuous monitoring and correction of the position of the press belt are provided laterally relative to the direction of motion, such that a running out of the press belt to the side is prevented.

38. Device according to claim 37, characterized in that the means for monitoring the position of the press belt comprise mechanical and/or optical sensors.

39. Device according to claim 37, characterized in that the means for correcting the position of the press belt comprise adjusting means (23) that act at at least one of the rollers, in particular at their axes.

40. Device according to claim 19, characterized in that adjusting means are provided at several rollers, in particular at all rollers.

41. Device according to claim 27, characterized in that, as adjusting means, hydraulic cylinders are provided which can move the roller in the direction of the press roller.

42. Device according to claim 41, characterized in that the adjusting means are arranged to the right and to the left of the roller.

43. Device according to claim 41, characterized in that the adjusting means can be individually activated and/or moved.

44. Device according to claim 41, characterized in that the pressure roller can be guided towards the press roller absolutely parallel.

45. Device according to claim 41, characterized in that an electronic control system is connected with the adjusting means such that the pressure roller can be pressed parallel against the main roller.

46. Device according to claim 1, characterized in that a transport belt (24) is provided such that the mat can be guided, by means of the transport belt, to the area from which the mat is introduced into the press diagonally from above.

47. Device according to claim 1, characterized in that the device comprises a casing.

48. Device according to one of the preceding claims claim 47, characterized in that the casing comprises openings for monitoring production or for performing a cleaning of the interior of the device.

49. Device according to claim 46, characterized in that, between the transport belt and the entry into the press, a transfer area (25) is provided that bridges the area between the transport belt (24) and the entry into the press.

50. Device according to claim 49, characterized in that means for heating the transfer area are provided which are able to pre-heat the mat that is in contact with it, immediately prior to entry into the press.

51. Device according to claim 49, characterized in that, at the transfer area and/or above the transfer area, means for supplying vapor are provided which supply vapor to the mat.

52. Device according to claim 1, characterized in that means (60) for treating the rollers and/or the press belt are provided.

53. Device according to claim 52, characterized in that the treatment means comprise polishing apparatuses for polishing the press roller or the press belt.

54. Device according to claim 52, characterized in that the treatment means are movable in an oscillating manner parallel to the circumferential surface of the press roller or of the press belt.

55. Device according to claim 52, characterized in that means (11) are provided for driving the treatment means towards or away from the press roller or the press belt.

56. Device according to claim 53, characterized in that the polishing apparatus is provided such that it is only driven up if needed.

57. Device according to claim 53, characterized in that the polishing apparatus comprises a roller with an abrasive belt.

58. Device according to claim 57, characterized in that the surface of the polishing apparatus has a very fine-grain corundum material.

59. Device according to claim 56, characterized in that a control system and sensors are provided such that the control system engages the polishing apparatus only when the sensors register shadings on the surface of the press roller, of the press belt or of the boards produced by means of the device.

60. Device according to claim 59, characterized in that the sensors comprise optical sensors.

61. Device according to claim 52, characterized in that the treatment means comprise one or more brushes (6), in particular wire brushes, which brush off the press roller (3) and/or the press belt (5).

62. Device according to claim 61, characterized in that the brushes or polishing apparatuses are provided such that treatment can be performed continuously during production.

63. Device according to claim 61, characterized in that the brushes (6) are arranged so that they brush perpendicularly to the direction of transport of the press belt.

64. Device according to claim 61, characterized in that the brush is arranged on a circulating belt (7), i.e., that it is designed as a belt brush.

65. Device according to claim 52, characterized in that, because of the means (11 for driving the treatment means (6)) towards or away, the treatment means (60) are arranged movably so that an optimal treatment of the press belt and/or of the rollers is also possible when the position of the press belt and/or of the rollers changes in the area of the treatment means, dependent on a desired board thickness to be produced.

66. Device according to claim 64, characterized in that the belt brush (7) is spanned by at least two rollers (8, 9).

67. Device according to claim 1, characterized in that it is formed such that, at first, a desired nip width between the press drum and the pressure roller is set, and subsequently, the line pressure that determines the raw density is set by a change in the material supply of the chip or fiber web.

68. (canceled)

69. Device according to claim 1, characterized in that it is formed such that one line sensor each is allocated to the edge regions on the side of the chip or fiber web.

70. Working method for the continuous production of chip or fiber webs wherein a chip or fiber web provided with a binding agent is subjected to a line pressure between a press drum (3) and a pressure roller (4) and additionally, to a surface pressure between a circulating belt (5) and the press drum (3), in order to generate a desired raw density, characterized in that at first, a desired nip width between the press drum (3) and the pressure roller (4) is set, and subsequently, the line pressure that determines the raw density is set by a change in the material supply of the chip or fiber web, wherein the line pressure is acquired by means of a pressure sensor.

71. (canceled)

72. Device according to claim 70, characterized in that one line sensor each is allocated to the edge regions on the side of the chip or fiber web.
